(19) United States
(12) Patent Application Publication
(10) Pub. No.: US 2007/0095399 A1
(43) Pub. Date: May 3, 2007

(54) Valve system

(76) Inventor: Thomas Henry Bell, Perth (GB)

Correspondence Address: KED & ASSOCIATES, LLP, P.O. Box 221200, Chantilly, VA, 20153-1200, US

(21) Appl. No.: 10/561,869

(22) PCT Filed: Jun. 24, 2004
(86) PCT No.: PCT/GB04/02733

§ 371 Date: Dec. 21, 2005

(30) Foreign Application Priority Data
Jun. 24, 2003 (GB) 0314680.0

(51) Int. Cl. F16K 21/18

(52) U.S. Cl. 137/403

(57) ABSTRACT

An improved valve system is described that comprises a diaphragm (9) and a means (3,4) for transferring a fluid pressure from a head of fluid to the diaphragm. The valve system operates on the principle that the pressure associated with a head of fluid can be transferred to diaphragm and be employed to control the position of the diaphragm. Being able to control the position of the diaphragm allows the valve system to find numerous applications in an environment where action may be required in response to a rising fluid levels e.g. the control of water levels with cisterns or marine vessels, or as a portable flood barrier.

The present invention relates to a new type of valve system. In particular, it relates to a valve system which can be used to control a cistern or water tank filling, or to control inflation devices.

One of the most common valves in use in the home today is the ball float valve which can be found in practically every home that contains a flushed WC or a storage system. Although there are different ball float valves on the market, the majority of differences between the valves are purely aesthetic. Although the initial cost of the ball float valve makes it a practical device for controlling water levels in the cistern, there are a number of problems with the valves that up until now have not been addressed. Firstly, maintenance of the valves after a period of time can be expensive, especially if replacement is required.

Another common problem with ball float valves is their failure, resulting in the external overflowing of water, which can cause structural damage if not checked in time, in addition to a waste of energy and water.

Yet another important problem with ball float valves is that the length of the arm and ball can restrict the size and shape of the vessel into which it is fitted, this is particularly noticeable in the case of flushing systems. The fittings attached to a WC, such as the handle for flushing, and a siphon also must be arranged in a set position to accommodate the valve.

As mentioned above, some manufacturers have tried to address these problems by redesigning the ball and lever position to work within the vertical plane of the valve. Another method is to use an equilibrium type valve which has a shorter ball and lever. Nevertheless, the general problems still exist in all of these amended valve types.

Ball float valves are automatic in action, with the principal design involving the use of a buoyancy float at the end of a lever, exerting its upward force on the end of a piston or similar device to close the orifice from which water is flowing. Currently on the market the only alternatives are water storage vessels that have been fitted with special control valves, such as motorised valves, or WCs fitted with flushing valves. These alternatives can be expensive and in many cases have to be supplied from a storage system that also uses a ball float valve. All ball float valves are graded in accordance with the water pressure they are required to withstand and the orifice through which the water flows. A whole array of valves are available to cope with the different water pressures, to ensure the reasonable supply of water to a cistern. The main type of ball float valves available on the market currently are high pressure, low pressure, full-way and equilibrium valve.

In a high pressure valve, the orifice will be proportionally smaller than a low pressure valve with the same rate of flow. Whereas, in a full-way valve, which is installed where low pressure flow rates exist, there is a larger orifice than that of a low pressure valve. Conversely, a high pressure equilibrium valve works on the principle that it transmits equal pressure to either end of its piston, such that the buoyancy of the ball does not have to withstand the pressure on the piston. Therefore, a larger orifice can be proportionally larger to that of a high pressure valve.

It can be seen that it would be beneficial to be able to provide a new type of valve system which does not suffer the same restrictions as the ball float valve system, but which can be used to control water levels in a similar manner.

It would also be useful to provide a valve system that is able to control other fluid levels as well, such as air levels. This could be particularly useful in situations such as flood barriers, wherein when the water level rises, an increase in air pressure can be used to inflate a flood barrier.

A yet further object of the present invention is to provide a valve system that does not experience the limitations associated with ball valves described in the prior art.

According to a first aspect of the present invention there is provided a valve system for use with a variable head of fluid, the valve system comprising a first diaphragm and a means for transferring a fluid pressure associated with the variable head of a first fluid to the first diaphragm wherein the position of the first diaphragm is controlled by the fluid pressure associated with the variable head of the first fluid.

Most preferably the valve system is deployed so that the first diaphragm is located above the variable head of fluid.

Preferably the valve system is connected to a supply line to the variable head of the first fluid such that the first diaphragm moves between an open position wherein the first fluid is free to flow within the fluid supply line and a closed position wherein the first fluid prevented from flowing within the fluid supply line.

Optionally the first diaphragm comprises blocking means to assist the first diaphragm move to the closed position.

Preferably the means for transferring a fluid pressure associated with the variable head of the first fluid comprises a compressible second fluid.

Optionally the compressible second fluid is contained within one or more tubes connected at a first end to the first diaphragm and positioned so that when in use the second end of the one or more tubes are located below the surface of the head of variable fluid.

Optionally the first diaphragm comprises an inflatable element so that the valve system can be employed as a flood barrier.

Most preferably the tube is connected to the first diaphragm via a diaphragm valve.

Preferably the means for transferring a fluid pressure further comprises one or more chambers located between the diaphragm valve and the first diaphragm.

Most preferably the first diaphragm comprises an aperture that provides a means for communicating a sample taken from the supply line to the variable head of the first fluid to the one or more chambers.

Preferably when the diaphragm valve moves to a closed position a pressure build up in the one or more chambers so causing the first diaphragm to move from the open position to the closed position.

Optionally the valve system further comprises an adjuster wherein the adjuster provides a means for varying the dependency of the position of the first diaphragm to the fluid pressure associated with the variable head of the first fluid.

Optionally the adjuster comprises a plurality of apertures and a sleeve located on an outer surface of the tube wherein the sleeve provides a means for covering one or more of the plurality of apertures.

Alternatively the adjuster comprises a means for varying the resistance required to activate the diaphragm valve. Preferably the means for varying the resistance required to activate the diaphragm valve comprises a bias means and an adjustment screw wherein the position of the adjustment screw defines the resistance force applied by the bias means to the diaphragm valve.

Optionally the valve system further comprises an automatic cut off means so that in the event of mechanical failure the valve system is moved to the closed position.

Preferably the automatic cut off means comprises one or more sections of absorbent material wherein when the fluid is incident on the absorbent material expansion occurs so as to cause the diaphragm valve to close.

Optionally the diaphragm valve comprises a plunger that assists movement to the closed position. A further optional feature is that the diaphragm valve further comprises a lever gate that further assists the movement to the closed position.

Optionally the means for transferring a fluid pressure comprises a second diaphragm and actuating rod connected at first end to the second diaphragm wherein the second diaphragm is located below the surface of the head of fluid and provides a means for varying the position of the actuating rod.

Preferably the means for transferring fluid pressure further comprises a pin connected to a second end of the actuating rod, an aperture located within the first diaphragm and one or more chambers located below the first diaphragm wherein movement of the actuating rod causes the position of the pin to move relative to the first diaphragm and the one or more chambers.

Most preferably the pin comprises one or more central sections of a first diameter that is smaller than a second diameter of end sections of the pin such the position of the pin determines whether fluid from the supply can enter the one or more chambers.

Preferably the first diaphragm is in the closed position when the pin is located so as to allow fluid to enter the one or more chambers. Thus the first diaphragm is in the open position when the pin is located so as to prevent fluid from entering the one or more chambers. When the first diaphragm is in the open position fluid within the one or more chambers is expelled via one or more capillaries.

Optionally the means for transferring fluid pressure further comprises a second bias means to aid the first diaphragm move from the closed position to the open position.

Optionally the compressible second fluid is air.

Alternatively the compressible second fluid is water.

According to a second aspect of the present invention, there is provided a valve system which comprises:
a first chamber; and
a compression tube which leads into the first chamber

wherein the compression tube contains a first fluid and a second fluid, and wherein an increase of the second fluid in the compression tube compresses the first fluid, resulting in a transposition of pressure into the first chamber.

According to a third aspect of the present invention, there is provided a valve system according to the first aspect of the present invention, adapted to regulate water levels in a cistern.

According to a fourth aspect of the present invention, there is a provided a valve system according to the first aspect of the present invention adapted to be used in a flood defense system.

In order to provide a better understanding of the present invention, embodiments of the invention will now be described by way of example only and with reference to the following drawings, in which:

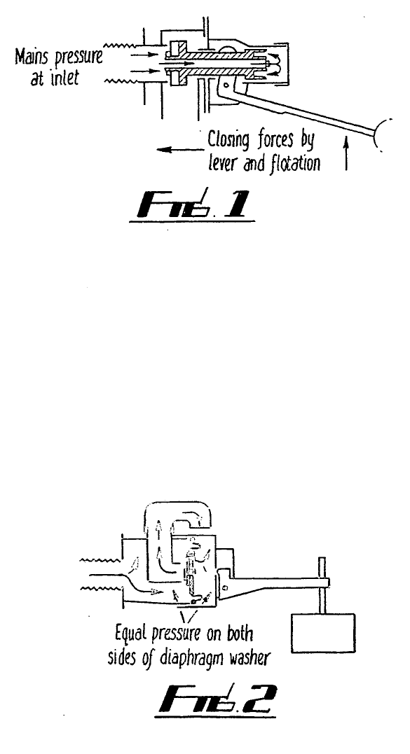

FIG. 1 shows a prior art Portsmouth equilibrium float valve;

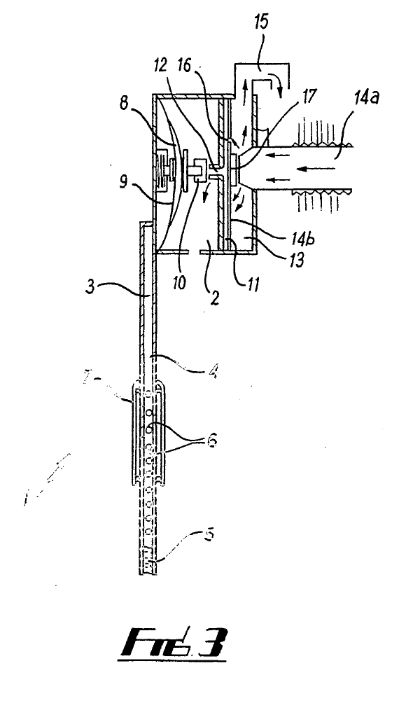

FIG. 2 shows a prior art diaphragm equilibrium float valve ;

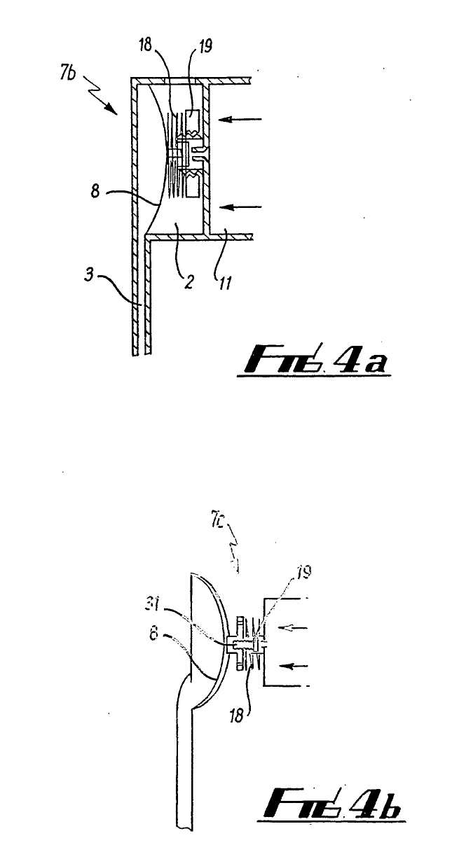

FIG. 3 presents a diagram of a valve system for use in regulating water levels(i.e. in a standard flushed WC) in accordance with an aspect of the present invention;

FIG. 4 shows two alternative pressure spring adjusters employed with the valve system of FIG. 3;

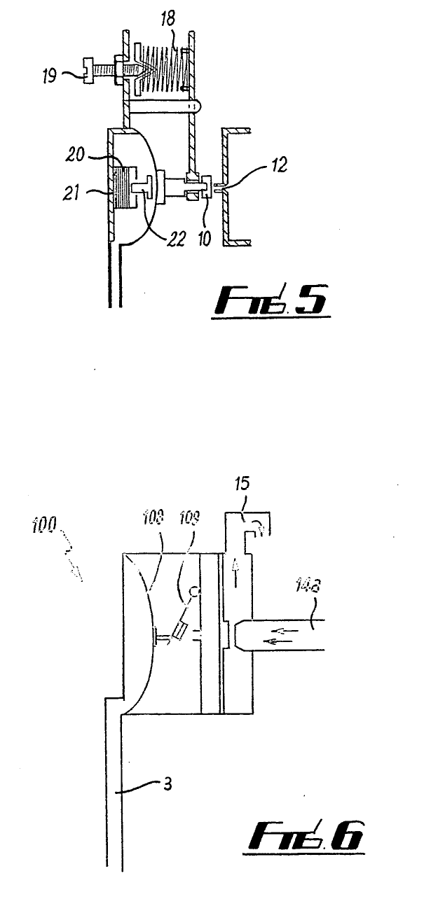

FIG. 5 shows an automatic cut-out employed with the valve system of FIG. 3;

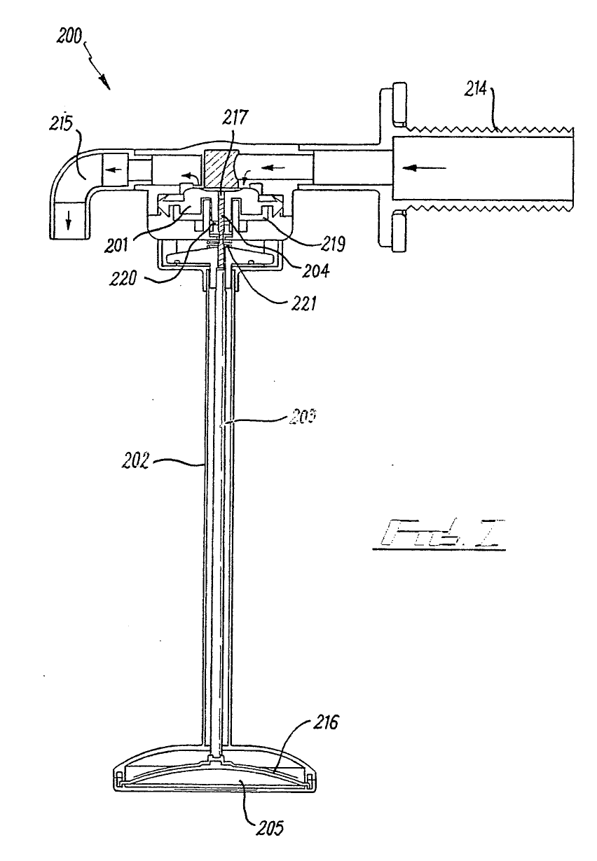

FIG. 6 presents a diagram of an alternative embodiment of the valve system that comprises a gate closure;

FIG. 7 presents a diagram of a yet further alternative embodiment of the valve system that comprises a diaphragm suitable for location under a water level within a cistern;

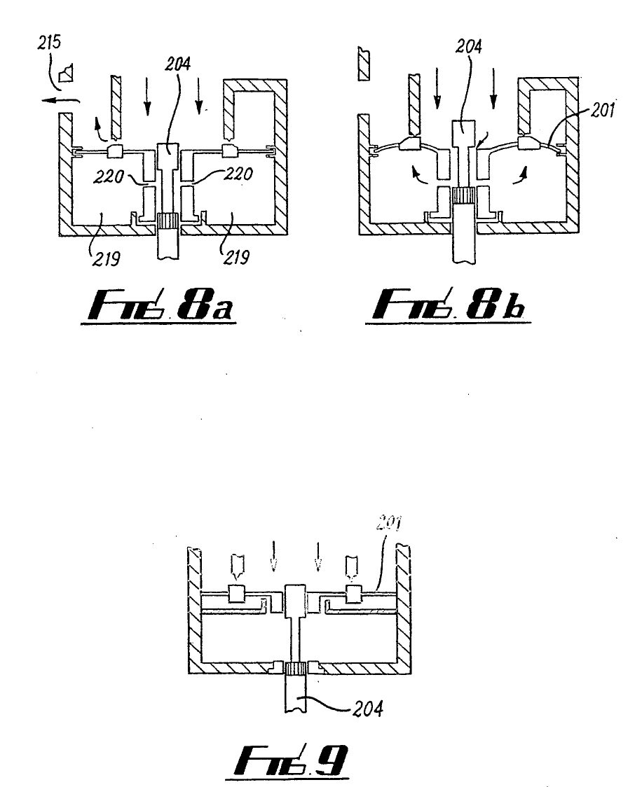

FIG. 8 presents further detail of the operation of a needle diaphragm valve of the valve system of FIG. 7 in:

(a) an open configuration; and

(b) a closed configuration;

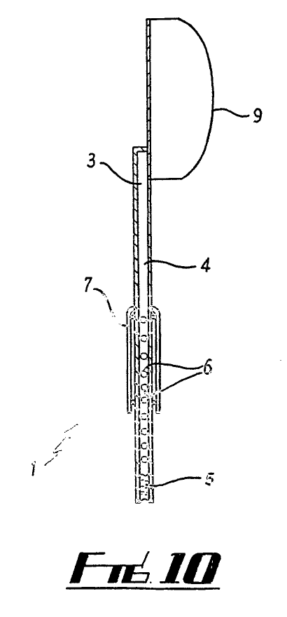

FIG. 9 presents an alternative embodiment of the needle diaphragm valve of FIG. 8; and

FIG. 10 is a diagram of the valve system of FIG. 1 employed as an automatic flood barrier in accordance with an aspect of the present invention.

### WORKING PRINCIPLES

In order to fully understand the working principles behind the new valve system, it is important to understand force and water pressure.

Water pressure acting on the base of a tank is proportional to the head of water and not just the volume of liquid present in the tank. For example, the pressure at the base of a tank with a 1 m² base, holding 1 m³ of water is the same as a tank with a 10 m² base, holding 10 m³ of water. However, the force acting on the base of the larger tank is greater.

In the described valve system, one aspect of the invention is concerned with the closing off of incoming water to any cistern or tank without the use of a ball float valve and lever. The design utilizes the fact that an alternative pressure can be exerted to close the orifice from which water is flowing and in fact, if reclaimed, a much greater pressure can be achieved. By experimentation, it was found that by placing a manometer tube into a tank, the head of water at the base of a tank will register a head of water on the manometer, even if the manometer tube is held above the tank. This effect occurs because the force of the water at the base of the tube transfers the water pressure via the air in between the two water columns. However, it should be noted that to register nearly the same bottom tank pressure on the manometer, the volume of air between the tube must be of such a capacity that this transposition takes place with a minimal loss of registered pressure head. Therefore, too great or too little a volume of air in-between the tubes would result in the prevention of any significant movement of water in the manometer. It is known that the volume of a fixed mass of air or any gas at a constant temperature is always inversely proportional to the pressure (according to Boyle's Law). Therefore, the volume of air in between the water and the tank and the manometer can be calculated to maximise the pressure transposition. For example, if the volume of air in a tube is halved, the pressure is doubled, and vice versa.

An example of the principles in action is shown below.

Where P=absolute pressure=101.33 kPa, V=volume, C=constant and P₁V₁=P₂V₂ (the application of this equation enables a difference in volume to be determined).

In order to find the pressures of air in a tube and confirm the pressure head, the following calculation can be carried out. The initial volume of the tube is:
Πr²h=3.142×0.006×0.006×0.480=0.0000542m³

When water is added to create a pressure head of 300 mm, the upthrust due to the pressure reduces the height of air within the tube by 15 mm. This volume can be calculated as follows:

$$3.142 \times 0.006 \times 0.006 \times ( 0.480 - 0.15 ) = .0000525 {m}^{3}$$

$${P}_{1} = 101.33$$

$${V}_{1} = .0000542$$

$${V}_{2} = .0000525$$

$${P}_{2} = ? \\ Where {P}_{1} {V}_{1} = {P}_{2} {V}_{2} , then {P}_{2} = \frac{{P}_{1} {V}_{1}}{{V}_{2}}$$

$$Which = \frac{101.33 \times 0.0000542}{0.0000525}$$

$$Which = \frac{104.66 - gauge 101.33 = 3.82 KN pressure in tube}{9.81}$$

Which=0.334 m approximate pressure head

By experimentation, it was found that only 5% of pressure head was lost when 300 mm head of water was applied. This is due to the upthrust pressure of the water in the inner tube, compressing the air until the pressure equalises with the applied water pressure. When the pressure head is reduced to half, the upthrust is proportionally reduced.

When the volume of air within the tube is increased to 960 mm, the percentage of upthrust is increased, reducing the pressure head.

However, sealed tubes of different diameters but similar lengths inserted into the water vessels for the same pressure head will produce the same upthrust (as explained previously).

However, although a force of water can be transferred from the base of a tank to the upward area to nearly equalise against the similar force, in practice the pressure head within a cistern acting on the base would generate an insufficient force to act on a piston or similar device to close an orifice from which water is flowing. However, by acting the force on a larger area, this would produce an adequate force to act on the piston or similar device to close the orifice. This is because the greater the area, equals the greater the force.

The fact that water or air pressure equalises in all directions, means that the transposition of water pressure by air from a much small area to a larger area will greatly increase its force. However, it should be noted that the air volume must be of certain cubic capacity to maximise the pressure.

The new valve system operates as there is a correlation between the size of the diaphragm and the pressure head available, i.e., the greater pressure head, the smaller the diaphragm, the smaller the pressure head the greater the diaphragm. In the present invention, due to variable water pressures and different markets, the cistern will be arranged for an option in size for the domestic market, but can be proportionally altered to be adapted for industrial uses, etc.

Example of the Valve System

FIG. 3 shows a diagram of the valve system 1 for use relating to closing off automatically any incoming water to a cistern or tank. The water enters the valve system 1 through the inlet tube 14a. It is unimpeded in flow when the valve system 1 is open. The water flows through the inlet tube 14a into the third chamber 13 and fills the cistern through the outlet tube 15. At the same time, water flows into the second chamber 11 through the metering hole 16 incorporated in the flexible diaphragm 14b. The water in the second chamber 11 seeps out through the inlet hole 12 into the first chamber 2, which prevents any build up of pressure in the second chamber 11. This results in the pressure on either side of the flexible diaphragm 14b being equalised, resulting in no movement of the flexible diaphragm 14b. In this state, the new valve system 1 is fully open.

However, as the cistern fills with water, it covers the compression tube 3 and any adjuster holes 6 that have not been covered by a removable seal 7. A pressure head of water starts to build up in the compression tube 3, compressing the air within the compression tube 3. When the water level reaches a predetermined height in the cistern to generate sufficient pressure, it acts on the diaphragm valve 8. In the preferred embodiment there is a surrounding cage around the diaphragm valve 8 which prevents any back pressure occurring, such that the diaphragm valve 8 extends forward, such that its plunger 10 is compressed against the inlet hole 12, closing the water seepage off. When this occurs, pressure within the second chamber 11 builds up until it equalises with the incoming water pressure which causes the inner flexible diaphragm 14b and blocking means 17 to move forward, closing off the water from the inlet tube 14a. In this state the valve 1 is fully closed.

When the water level in the cistern falls, the pressure in the compression tube 3 is reduced, which automatically results in the diaphragm valve 8 moving back, opening the inlet hole 12, such that water seepage again occurs from the second chamber 11 into the first chamber 2. The result is that the flexible diaphragm 14b drops back into its original position so that the inlet tube 14a is no longer blocked by the blocking means 17.

It will be appreciated by those skilled in the art that an anti-siphon means (not shown) can also be connected to the outlet tube 15. The anti-siphon means can be in the form of a pipe designed to prevent foul water from the cistern entering the main service pipes. This can occur if the water supply to the cistern is turned off when the cistern is full. The anti-siphon means may alternatively be in the form of a soft rubber hinged flap that in operation acts as a one way valve.

Slide Sleeve Water Level Adjuster

In order to adjust the pressure required to close off the valve system 1, the compression tube 3 comprises a series of level adjuster holes 6 drilled into it at different levels. The level adjuster holes 6 can then be covered with an outer removable seal 7. When this removable seal 7 is moved upwards along the length of the compression tube 3, it exposes further level adjuster hole 6 so breaking the pressure head and thus allowing more water into the cistern before the diaphragm needle valve 8 activates. When the removable seal 7 is pushed downwards, it allows less water into the cistern before the diaphragm needle valve 8 activates.

Compression Spring Adjusters

FIG. 4a shows an alternative adjuster 7b that can be fitted to change the amount of water required to activate the diaphragm valve 8 to close off the valve system 1. The adjuster comprises se typ a compression spring adjusters that can be mounted at any position. In the described embodiment the adjuster 7b is located in the middle of the body of the valve system 1.

Alternatively, as shown in FIG. 5 the adjuster 7b can be located on top of the body of the valve. To adjust the water level, the thumb or adjuster screw 19 is turned to compress the spring 18 which causes a resistance on the diaphragm valve 8, forcing it further away from the face of the inlet hole 12. Therefore, more water has to enter the cistern to build up a greater pressure head to push the diaphragm valve 8 forward further to close the inlet hole 12.

In FIG. 4b a yet further alternative adjuster 7c is presented. In this embodiment the spring 18 of the adjuster 7c is not in direct contact with the diaphragm 8. Instead the spring 18 is mounted on a stopper shaft 31 so that the adjuster screw 19 is now in contact with the diaphragm 8. The adjuster 7c then operates in a similar manner to that described above. When the adjuster screw 19 is turned on the stopper shaft 31 the length of the stopper shaft 31 available to interact with the inlet hole 12 can be varied. A longer length results in less water being required to enter the cistern before the valve 1 is closed off. Conversely a shorter length results in more water being required to enter the cistern before the valve 1 is closed off.

Automatic Cut-Out

An automatic cut-out can be included in the valve system 1 to ensure that if the valve system 1 fails, and the water levels in the cistern rise to an undesirable level, automatic cut-out will occur. FIG. 5 shows a diagram of the automatic cut-out system. The automatic cut-out consists of a number of water absorbent washers 20 housed in a cup-type chamber 21 positioned in the diaphragm valve 8. If, during operation, the valve system 1 fails and does not cause the diaphragm valve 8 to push forward to close the inlet hole 12, water would automatically enter the first chamber 2 behind the diaphragm valve 8. When this occurs, the water absorbent washers 20 housed within the chamber will automatically increase in volume due to water absorption. This increase in volume will force a cut-out plunger 22 attached to the water absorbant washers 20 to move forward, pushing the normal plunger 10, such that it closes the inlet hole 12. In this manner, any overflowing or wastage of water will be prevented, even if the valve system 1 fails for any reason.

In an alternative embodiment of the automatic cut-out (not shown) the cup-type chamber 21 is sealed with a chamber lid and a rubber seal. Holes are then provided within the cup-type chamber 21 that is also employed to house a spring (not shown). When water enters the cup-type chamber via the holes the water absorbent washers 20 are again caused to expand such that, in combination with the bias force of the spring, they eventually overcome the restraining force of the chamber lid. As a result the seal is broken resulting in the plunger 10 being pushed forward and so closing the inlet hole 12.

Alternative Embodiments

An alternative embodiment of the valve system 100 is presented in FIG. 6. In this embodiment movement pressure within the compression tube 3 again control the position of a diaphragm valve 108 that in turn operates a lever gate 109. The valve system then operates in a similar manner to that described above.

FIG. 7 presents a diagram of a yet further alternative embodiment of the valve system 200 in this embodiment the valve system 200 comprises first and second diaphragms 201 and 205 located at opposite ends a sealed water protection tube 202. During operation the second diaphragm 205 is located under the water level within a cistern while the sealed water protection tube 202 extends above the water level. Located within the water protection tube 202 is an actuating rod 303 the top end of which is attached a pin 204. From FIG. 8 it can be seen that the pin 204 comprises a dumbbell shape and is orientated so as to interact with the first diaphragm 201 (as described in detail below).

Located above the first diaphragm 201 is an inlet tube 214 that provides a means for water to enter the valve 200. The water is routed across the top of the first diaphragm 201 before exiting the valve 200 through an outlet tube 215.

The operation of the valve 200 is as follows. When water enters the valve 200 the first diaphragm 201 is moved by the pressure of the input water to an open position, as depicted by FIG. 8a. Water then fills the cistern through the outlet tube 215. As the system fills with water it rises up the outside of the water protection tube 202 and a pressure head is formed. This pressure head then acts on the second diaphragm 205. A diaphragm cage 216 is harnessed to the second diaphragm 205 so as to prevent any back pressure being experienced by the second diaphragm 205.

As the pressure head grows the second diaphragm 205 is forced upwards so as to engage with the actuating rod 203. The actuating rod 203 and thus the pin 204 are also forced to move upwards. This upward movement results in the pin 204 being pushed through an orifice 217 located in the centre of the first diaphragm 201 which is otherwise fixed in position. As the pin 204 continues to move upwards its larger top diameter protrudes through the upper face of the first diaphragm 201 so as to expose the central smaller diameter section. At this point water is allowed to enter into chambers 219 located below the first diaphragm 201, via harass weep holes 220. As the cistern continue to fill the ongoing movement of the lower part of the pin 204, which is equal in diameter to the top part, then plugs the lower part of first diaphragm orifice 217. When this occurs water pressure within chambers 219 builds up so that it has equalised with the incoming water pressure and so causes the upper face of the first diaphragm 201 to again move upwards to the closed valve position, as shown in FIG. 8b.

It should be noted that since the surface area with which the water in chambers 219 can interact with the first diaphragm 201 is greater than the surface area with which the water from the inlet tube 214 can interact with the first diaphragm 201 there is a greater face resistance provided on the lower side of the first diaphragm 201 than on the upper side. The overall result of the pressure balance and upper and lower face resistance is that the first diaphragm 201 is maintained in this closed position.

When the cistern is emptied of water the pin 204 is forced downwards by a spring 221 and so plugs the upper side of the second diaphragm orifice 217 so as to prevent further water entering into the chambers 219. At the same time the lower part of the pin 204 slightly protrudes through the bottom of the first diaphragm orifice 217 so as to expose the smaller diameter section of the pin 204. In this pin position water within chambers 219 is able to exit the valve system 200 via small capillaries (not shown) back into the cistern. This results in the valve system 200 moving from the closed position of FIG. 8b to the open position of FIG. 8a and so the above described cycle can commence all over again.

In an alternative embodiment the weight of the actuating rod is employed to aid in moving the valve system 200 from the closed position to the open position. This embodiment removes the requirement for the spring 221 to be present.

FIG. 9 presents an alternative configuration for the first diaphragm. In this configuration the diaphragm has been separated into two distinct parts. However, operation of the pin 204 and the two-part diaphragm is similar to that described above.

Within a cistern the valve system 1 and 100 can be mounted in a variety of ways. For example the valve system can be mounted in a disc like casing and connected via a flexible inlet tube 14a. Such a design provides great flexibility in the choice of location for the valve system 1 and 100 within the cistern.

Alternative Applications

Although the valve system 1, 100, 200 can be ideally used to regulate water flow in a cistern, as described in the above embodiment, it also has a number of alternative uses.

FIG. 10 shows a diagram of another possible use for the new valve system 1, as an automatic flood barrier. It can be seen that as in the previous embodiment there is a compression tube 3 and a level adjuster holes 6. A removable seal 7 can also be included, if required. The compression tube 3 leads to the first chamber 2, which comprises a flexible material 9. However, instead of the flexible material 9 being in the form of a diaphragm valve 8, as in the previous embodiments, the flexible material simply inflates in response to the increase in pressure within the compression tube 3. As will be appreciated by those skilled in the art the flexible material does not necessarily have to be the first chamber, but may alternatively be in a second, third or fourth chamber, etc., which is joined to the first chamber in some manner. If this system is used in a river, the compression tube 3 will be used on the river bank with the first chamber 2 incorporating the flexible material 9 being present on the riverbank. As river levels rise, water will enter the compression tube 3 at higher and higher levels, causing the flexible material 9 to inflate in response to the pressure increase within the compression tube.

In an alternative flood barrier system (not shown) the valve system is produced on a larger scale and housed in a pit or tank on a riverbank, or the like, or on the coast so as to monitor tides. The flexible chamber 9 is then connected to an actuating arm that is in turn is connected to a substantially horizontal barrier. At times when the river floods or high tides occur, water enters the pit or tank causing an increase in pressure in the compression tube and hence inflation of the chamber 9. The causes the actuating arm to rotate the barrier from a substantially horizontal position to a vertical position so as to form a temporary flood barrier. When the water recedes the pit or tank can be drained off so that the barrier returns to the substantially horizontal position.

In an alternative use the valve system is employed as a containment barrier for oil spills and the like. Here the compression tube 3 leads to a first chamber 2, which itself incorporates a flexible material 9. When dropped into a body of liquid such as the sea around the periphery of an oil or chemical spill the flexible material will inflate to form a containment barrier. The compression tube and any internal valve units (if required) will be prepared such that as soon as the compression tube 3 is place in position the pressure would be sufficient to immediately inflate the barrier.

In a further alternative use the valve system is employed as to actuate a micro switch or other similar device. This finds particular application for the controlled operation of an electrical bilge pump employed to remove water from a sea vessel. Similarly the micro switch could simply activate a warning device so as to indicate to persons on the sea vessel that water was collecting within the bilge.

In a similar manner the valve system can be employed to monitor ballast systems commonly found within sea vessels for the purpose of stabilisation. Ballast systems typically employ water as the stabilisation medium hence the valve system can be used to indicate if there is too much ballast entering the vessel or if the ballast is unevenly distributed within the ballast tanks of the vessel. Furthermore the valve system could be employed to activate one or more pumps so as to address the problems of unsafe ballast conditions.

It can be seen that the valve system has a number of advantages over prior systems, in that it can be manufactured in a compact manner, it is easy to install and use, and maintenance costs should be relatively low.

The embodiments disclosed above are merely exemplary of the present invention, which may be embodied in different forms. Therefore, the details disclosed herein are not to be interpreted as limiting, but merely as a basis for the claims and for teaching one skilled in the art as to the various uses of the present invention in any appropriate manner.

1. A valve system for use with a variable head of fluid, the valve system comprising a first diaphragm and a means for transferring a fluid pressure associated with the variable head of a first fluid to the first diaphragm wherein the position of the first diaphragm is controlled by the fluid pressure associated with the variable head of the first fluid.

2. A valve system as claimed in claim 1 wherein when the valve system is deployed the first diaphragm is located above the variable head of the first fluid.

3. A valve system as claimed in claim 1, wherein the valve system is connected to a supply line to the variable head of the first fluid such that the first diaphragm moves between an open position, wherein the first fluid is free to flow within the fluid supply line, and a closed position, wherein the first fluid is prevented from flowing within the fluid supply line.

4. A valve system as claimed in claim 1, wherein the first diaphragm comprises a blocking means to assist the first diaphragm move to the closed position.

5. A valve system as claimed in claim 1, wherein the means for transferring a fluid pressure associated with the variable head of the first fluid comprises a compressible second fluid.

6. A valve system as claimed in claim 5 wherein the compressible second fluid is contained within one or more tubes connected at a first end to the first diaphragm and positioned so that when in use the second end of the one or more tubes are located below the surface of the head of variable first fluid.

7. A valve system as claimed in claim 5, wherein the first diaphragm comprises an inflatable element so that the valve system can be employed as a flood barrier.

8. A valve system as claimed in claim 6, wherein the tube is connected to the first diaphragm via a diaphragm valve.

9. A valve system as claimed in claim 8 wherein the means for transferring a fluid pressure further comprises one or more chambers located between the diaphragm valve and the first diaphragm.

10. A valve system as claimed in claim 9 wherein the first diaphragm comprises an aperture that provides a means for communicating a sample taken from the supply line to the variable head of the first fluid to the one or more chambers.

11. A valve system as claimed in claim 9, wherein when the diaphragm valve moves to a closed position a pressure build up in the one or more chambers so causing the first diaphragm to move from the open position to the closed position.

12. A valve system as claimed in claim 1, wherein the valve system further comprises an adjuster wherein the adjuster provides a means for varying the dependency of the position of the first diaphragm to the fluid pressure associated with the variable head of the first fluid.

13. A valve system as claimed in claim 13 wherein the adjuster comprises a plurality of apertures and a sleeve located on an outer surface of the tube wherein the sleeve provides a means for covering one or more of the plurality of apertures.

14. A valve system as claimed in claim 12, wherein the adjuster comprises a means for varying the resistance required to activate the diaphragm valve.

15. A valve system as claimed in claim 14 wherein the means for varying the resistance required to activate the diaphragm valve comprises a bias means and an adjustment screw wherein the position of the adjustment screw defines the resistance force applied by the bias means to the diaphragm valve.

16. A valve system as claimed in claim 3, wherein the valve system further comprises an automatic cut off means so that in the event of mechanical failure the first diaphragm is moved to the closed position.

17. A valve system as claimed in claim 16 wherein the automatic cut off means comprises one or more sections of absorbent material such that when the first fluid is incident on the absorbent material expansion occurs so as to cause the diaphragm valve to close.

18. A valve system as claimed in claim 8, wherein the diaphragm valve comprises a plunger that assists movement to the closed position.

19. A valve system as claimed in claim 8, wherein the diaphragm valve further comprises a lever gate that further assists the movement to the closed position.

20. A valve system as claimed in claim 5 wherein the means for transferring a fluid pressure further comprises a second diaphragm and actuating rod connected at first end to the second diaphragm such that the second diaphragm is located below the surface of the head of fluid and provides a means for varying the position of the actuating rod.

21. A valve system as claimed in claim 20 wherein the means for transferring fluid pressure further comprises a pin connected to a second end of the actuating rod, an aperture located within the first diaphragm and one or more chambers located below the first diaphragm such that movement of the actuating rod causes the position of the pin to move relative to the first diaphragm and the one or more chambers.

22. A valve system as claimed in claim 21 wherein the pin comprises one or more central sections of a first diameter that is smaller than a second diameter of end sections of the pin such the position of the pin determines whether fluid from the supply can enter the one or more chambers.

23. A valve system as claimed in claim 21, wherein the first diaphragm is in the closed position when the pin is located so as to allow fluid to enter the one or more chambers.

24. A valve system as claimed in claim 21, wherein the first diaphragm is in the open position when the pin is located so as to prevent fluid from entering the one or more chambers.

25. A valve system as claimed in claim 24 wherein when the first diaphragm is in the open position fluid within the one or more chambers is expelled from the one or more chambers via one or more capillaries.

26. A valve system as claimed in claim 20, wherein the means for transferring fluid pressure further comprises a second bias means to aid the first diaphragm move from the closed position to the open position.

27. A valve system as claimed in claim 5, wherein the compressible second fluid is air.

28. A valve system as claimed in claim 5, wherein the compressible second fluid is water.
